(19) United States
(12) Patent Application Publication
(10) Pub. No.: US 2006/0294219 A1
(43) Pub. Date: Dec. 28, 2006

(54) Network system based on policy rule

(76) Inventors: Kazuki Ogawa, Kanagawa (JP); Nobuhiro Kawamura, Kawasaki (JP); Seiji Nomiyama, Fukuoka (JP); Katsuichi Nakamura, Saga (JP); Akira Imahase, Fukuoka (JP)

Correspondence Address: KATTEN MUCHIN ROSENMAN LLP, 575 MADISON AVENUE, NEW YORK, NY, 10022-2585, US

(21) Appl. No.: 10/571,048

(22) PCT Filed: Oct. 3, 2003
(86) PCT No.: PCT/JP03/12726

§ 371 Date: Mar. 3, 2006

(51) Int. Cl. G06F 15/173

(52) U.S. Cl. 709/224

(57) ABSTRACT

A policy control device for reflecting a policy rule defined by a condition and an action corresponding to the condition for operation setting of respective network devices present in a network to be managed, according to a transition of operation states of the network, including a storage unit for storing a plurality of multi-policy rules generated in units of combination of at least two single policy rules having different actions on the same condition, together with particular information of a network device to be applied, in such a manner that the plurality of multi-policy rules and the particular information can be updated; and a control unit for applying one of the plurality of multi-policy rules stored in the storage unit for the operation setting of the network device identified, based on the particular information.

### CROSS-REFERENCE TO RELATED APPLICATION

This is a continuation of application PCT/JP2003/012726, filed on Oct. 3, 2003, now pending, the contents of which are herein wholly incorporated by reference.

### BACKGROUND OF THE INVENTION

The present invention relates to a network system based on a policy rule, and more particularly to a network system based on a policy rule, capable of suppressing a monotonous increase in single policy rules brought about by an operation and greatly reducing loads on a network operator.

Recently, as Internet access systems, broadband access systems using ADSL (Asymmetric Digital Subscriber Line) and FTTH (Fiber to the Home), etc. have grown popular. Service providers such as a carrier (communication carrier or telecommunications carrier), ISP (Internet Service Provider), and IDC (Internet Data Center) have started to provide services of the broadband access system. As a result, traffic flowing through a network has greatly increased.

Such an increase in traffic has been accompanied by an increase in processing load on a network device which constitutes the network, causing transfer delay or discard of a packet through the network with the result of deterioration of service quality (QoS: Quality of Service). Thus, the service providers providing broadband information services, bidirectional voice communication services, or the like must execute a network operation procedure to provide stable service quality to a service user (user). Under these circumstances, a network operator (administrator) must generate optimal policy rules according to a network operation state, and many policy rules are generated depending on operation states, increasing loads on the network operator.

Additionally, there is a demand from the network operator for application of a plurality of policy rules to each network device which constitutes the network. For example, “when there is traffic congestion in a particular path, the traffic path will be changed, and traffic flowing through the network will be suppressed by a certain rate”, or “when a line of a particular path becomes a failure, the traffic path will be changed, and notification will be made to the network operator”. There is now a need for a policy rule application method (method, or technology) capable of flexibly dealing with such a demand from the network operator.

Now, one conventional method of operating an IP (Internet Protocol) network such as an MPLS (Multi Protocol Label Switching) network by a policy server will be described.

The policy server automatically reflects set policies to set operations of network devices present in the network when the network operator sets various network operation policies according to operation states of the network.

Various operation policies set by the network operator are policy rules constituted of conditions and operations (actions) corresponding thereto. In the conventional policy server, pieces of packet header information such as an IP address of a transmission source, a subnetwork mask, a port number, and the like, and an IP address of a transmission destination (destination), a subnetwork mask, a port number, and the like are generally used as a condition, or a time zone to which the policies are applied is generally used as a condition.

These pieces of policy information are created by network operation guidance predetermined by the network operator.

However, the following problems still remain even when the above-described conventional method is used. According to currently-operated primitive policies, as the operation progresses, policies managed/operated by the network operator monotonously increase, obstructing the effective operation.

As the management/operation method is not designed to enable understanding of the policy rules from a macroscopic standpoint, operation costs increase, and hierarchical management of the policy rules is impossible.

Furthermore, regarding the operation policies, the network operator decides an optimal policy among many created policies according to the operation state of the network, and applies it to the network to be operated. However, when many policies are created, management becomes difficult, and selection of an optimal policy also becomes difficult.

As proposed in Japanese Patent Application No. 2003-22731 (filed on Jan. 30, 2003) previously applied by the same applicant, there is available a policy application method based on a network operation state, which adds a policy to be applied and, changes or replaces the applied policy based on the network operation state.

Even in the case of employing this policy application method, however, the policy to be applied is an extremely primitive single policy which is independently present. When a policy to be applied is added or the applied policy is changed or replaced only based on the single policy, system loads increase, and operation loads on the network operator inevitably increase as described above.

The following is a related art to the present invention. [Patent document 1] Japanese Patent Laid-Open Publication No. 2002-204254

### SUMMARY OF THE INVENTION

It is an object of the present invention to provide a technique and a method capable of suppressing a monotonous increase in single policy rules brought about by an operation.

It is another object of the present invention to provide a technique and a method capable of greatly reducing loads on a network operator.

In order to solve the above-mentioned problems, the present invention provides a first policy control device for reflecting a policy rule defined by a condition and an action corresponding to the condition for operation setting of respective network devices present in a network to be managed, according to a transition of operation states (statuses) of the network, including: a storage unit for storing a plurality of multi-policy rules generated in units of combination of at least two single policy rules having different actions on the same condition, together with particular information of a network device to be applied, in such a manner that the plurality of multi-policy rules can be updated; and a control unit for applying one of the plurality of multi-policy rules stored in the storage unit for the operation setting of the network device identified, based on the particular information.

The present invention provides a second policy control device for reflecting a policy rule defined by a condition and an action corresponding to the condition for operation setting of respective network devices present in a network to be managed, according to a transition of operation states of the network, including: a storage unit for storing a plurality of single policy rules having different actions on the same condition, together with particular information of a network device to be applied and application priority information, in such a manner that the plurality of single policy rules can be updated; and a control unit for applying one of the plurality of single policy rules stored in the storage unit for the operation setting of the network device identified, based on the particular information according to an order of priority based on the priority information.

In the first or second policy control device, the condition contains at least one selected from among a line trouble, an excess of a traffic amount threshold value, and an excess of a packet loss threshold value each indicating operation states of the network to be managed, and the action contains at least two selected from among switching of a traffic flow path, flow control for suppressing traffic, and a notification to a network operator.

Also, the particular information of the network device to be applied contains identification information of the network device and identification information of a line interface.

Also, each of the plurality of multi-policy rules is generated in units of combination of at least two of the single policy rules having the different actions on the same condition preregistered in the storage unit, to enable hierarchical management of the plurality of multi-policy rules.

Also, the storage unit further stores application priority information of the plurality of multi-policy rules in such a manner that the application priority information can be updated, and the control unit applies one of the plurality of multi-policy rules for the operation setting of the network device according to an order of priority based on the priority information.

In addition, the storage unit further stores application priority information of the single policy rules in each of the plurality of multi-policy rules in such a manner that the application priority information can be updated, and the control unit applies the single policy rules in each of the plurality of multi-policy rules for the operation setting of the network device, according to an order of priority based on the priority information.

The present invention provides a first policy control method for reflecting a policy rule defined by a condition and an action corresponding to the condition for operation setting of respective network devices present in a network to be managed, according to a transition of operation states of the network, including: storing a plurality of multi-policy rules generated in units of combination of at least two single policy rules having different actions on the same condition, together with particular information of a network device to be applied, in such a manner that the plurality of multi-policy rules and the particular information can be updated; and applying one of the plurality of multi-policy rules stored for the operation setting of the network device identified, based on the particular information.

The present invention provides a second policy control method for reflecting a policy rule defined by a condition and an action corresponding to the condition for operation setting of respective network devices present in a network to be managed, according to a transition of operation states of the network, including: storing a plurality of single policy rules having different actions on the same condition, together with particular information of a network device to be applied and application priority information, in such a manner that the plurality of single policy rules, the particular information, and the application priority information can be updated; and applying one of the plurality of single policy rules stored for the operation setting of the network device identified, based on the particular information according to an order of priority based on the priority information.

According to the present invention, by enabling application of multi-policy rules combined with a single policy rule, it is possible to suppress a monotonous increase in single policy rules along with an operation.

According to the present invention, as a multi-policy rule which can be understood and managed from the macroscopic standpoint can be created only by selecting a single policy rule in operation, it is possible to reduce loads on the network operator.

Furthermore, according to the present invention, a plurality of policy rules can be simultaneously set by setting an order of priority among policy rules (single policy rules and multi-policy rules). By automatically selecting an optimal policy rule from the plurality of policy rules based on the order of priority according to an operation state of the network, management loads on the network operator can be greatly reduced. In addition, it is possible to achieve efficient operation of the network system itself.

Other objects, features, and advantages of the present invention will become apparent upon reading of the specification (embodiment) described below with reference to the drawings and a scope of appended claims.

### BRIEF DESCRIPTION OF THE DRAWINGS

FIG. 1 is a block diagram showing a configuration of a system and a policy server according to an embodiment of the present invention;

FIGS. 2A, 2B and 2C show tables showing policy rules applied to the system according to the embodiment of the present invention;

FIG. 3 is a diagram showing a registration sequence of policy rules;

FIG. 4 is a diagram showing a registration sequence of policy rules on which an order of priority is set;

FIG. 5 is a diagram showing a processing sequence of policy rule application;

FIG. 6 is a flowchart showing a processing flow of user interface unit of the policy server;

FIG. 7 is a flowchart showing a processing flow of policy management unit of the policy server;

FIG. 8 is a flowchart showing a processing flow of policy analysis unit of the policy server;

FIG. 9 is a flowchart showing a processing flow of network operation information collection unit of the policy server;

FIG. 10 is a flowchart showing a processing flow of network monitoring unit of the policy server;

FIG. 11 is a flowchart showing a processing flow of network state analysis unit of the policy server;

FIG. 12 is a flowchart showing a processing flow of optimal policy selection unit of the policy server;

FIG. 13 is a flowchart showing a processing flow of policy application instruction unit of the policy server;

FIG. 14 is flowchart showing a processing flow of policy application unit of the policy server;

FIG. 15 is a flowchart showing a processing flow of associated processing execution unit of the policy server;

FIG. 16 is a diagram showing a data structure of information managed by a policy management database of the policy server;

FIG. 17 is a diagram showing a data structure of information managed by a policy analysis database of the policy server; and

FIG. 18 is a diagram showing a data structure of information managed by a network management database of the policy server.

### DETAILED DESCRIPTION OF THE PREFERRED EMBODIMENTS

Referring to the accompanying drawings, the present invention will be described below more in detail. The drawings show preferred embodiments. However, the present invention can be implemented in many different forms, and it should not be construed to be limited to the embodiments described herein. Rather, the embodiments are provided so that the disclosure of the specification can be fully complete to sufficiently show a scope of the invention to those skilled in the art. Throughout the specification and the drawings, the same reference numerals indicate the same components.

[Configuration of System]

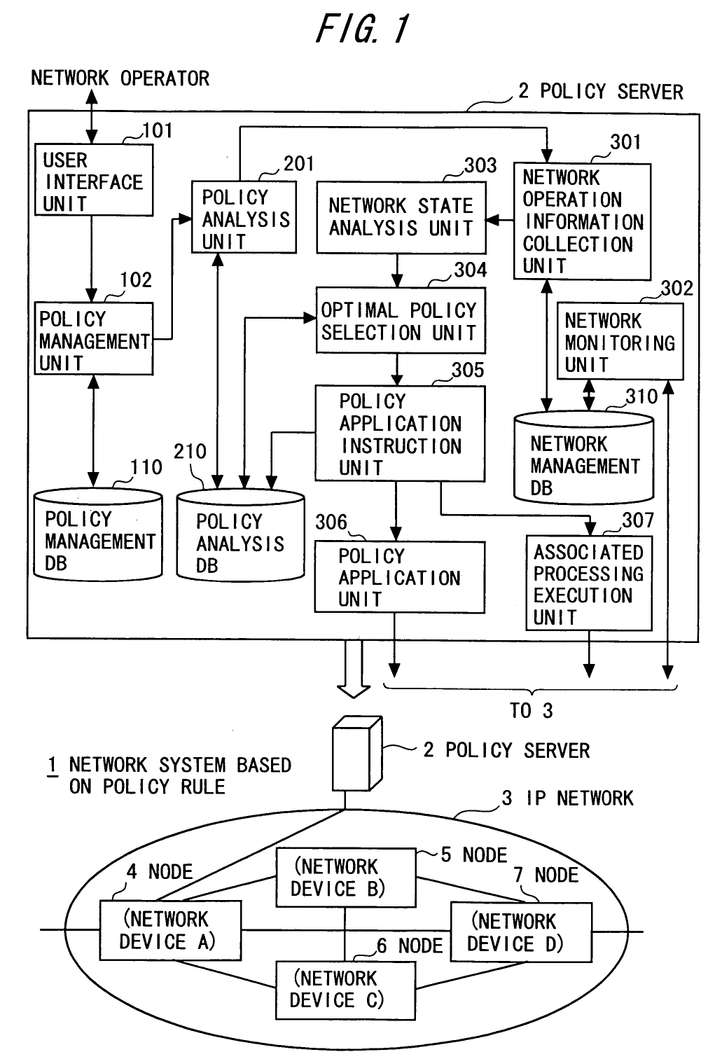

Referring to FIG. 1 which shows a system configuration of an embodiment of the present invention, a network system 1 based on a policy rule includes a policy server (policy control device) 2 and an IP (Internet Protocol) network 3.

The IP network 3 is specifically a label switch network such as an MPLS (Multi Protocol Label Switching) network, which adopts a new concept of label for IP packet transfer processing, and employs an MPLS technology of realizing routine processing at an IP level (layer 3) by switching processing of ATM (Asynchronous Transfer Mode), a frame relay, or a lower layer (layer 2) such as Ethernet. The IP network (simply referred to as network when not specified particularly) 3 includes a plurality of nodes 4 to 7 serving as network devices.

The policy server 2 is connected to the node 4 arranged at an entrance of the IP network 3 through a physical line (physical link). The node 4 arranged at the entrance of the network 3 and the node 7 arranged at an exit of the network 3 are connected to each other through the relay (core) nodes 5 and 6 and a physical line (physical link). Each of the entrance node 4 and the exit node 7 is connected to another IP network (not shown).

According to the network system 1 based on the policy rule that employs this configuration, the policy server 2 decides operations of the nodes 4 to 7 based on user information, policy (operation guidance) information, and a state (operation state) of the entire network, as described below. The policy server 2 controls the nodes 4 to 7 in a concentrated manner according to a policy control protocol such as COPS (Common Open Policy Service) to provide services regarding traffic engineering such as optimal path setting (explicit path (route) setting with consideration given to QoS, and aggregate (integration) of an IP flow) for each IP flow, and traffic load balance.

The entrance node 4, the relay nodes 5 and 6, and the exit node 7 are constituted of network devices, such as routers and switches, to transmit (including transfer, replacement, and the like) an IP packet, and execute operations according to the decision of the policy server 2. The entrance node 4 directly transmits/receives information to/from the policy server 2 according to the policy control protocol, while the relay nodes 5 and 6 and the exit node 7 transmits/receives information to/from the policy sever 2 through the entrance node 4.

[Function of System]

The network system 1 based on the policy rule shown in FIG. 1 has a function of permitting creation of a multi-policy rule constituted of a plurality of single policy rules by combining single policy rules which are primitive policies created by a network operation (administrator) using a maintenance/operation terminal through a user interface unit 101 of the policy server 2, or single policy rules created by customizing a template provided beforehand in the policy server 2. Accordingly, policy rule application based on a macroscopic standpoint is enabled, and it is possible to suppress an operation management load on the network operator.

The network system 1 additionally has a function of enabling a network operation based on a policy rule in the form of making systematically efficient an optimal policy to be applied to the network and sufficiently reflecting intention of the network operator, by setting of priority on single policy rules themselves or setting of priority on each single policy rule constituting the multi-policy rule by the network operator.

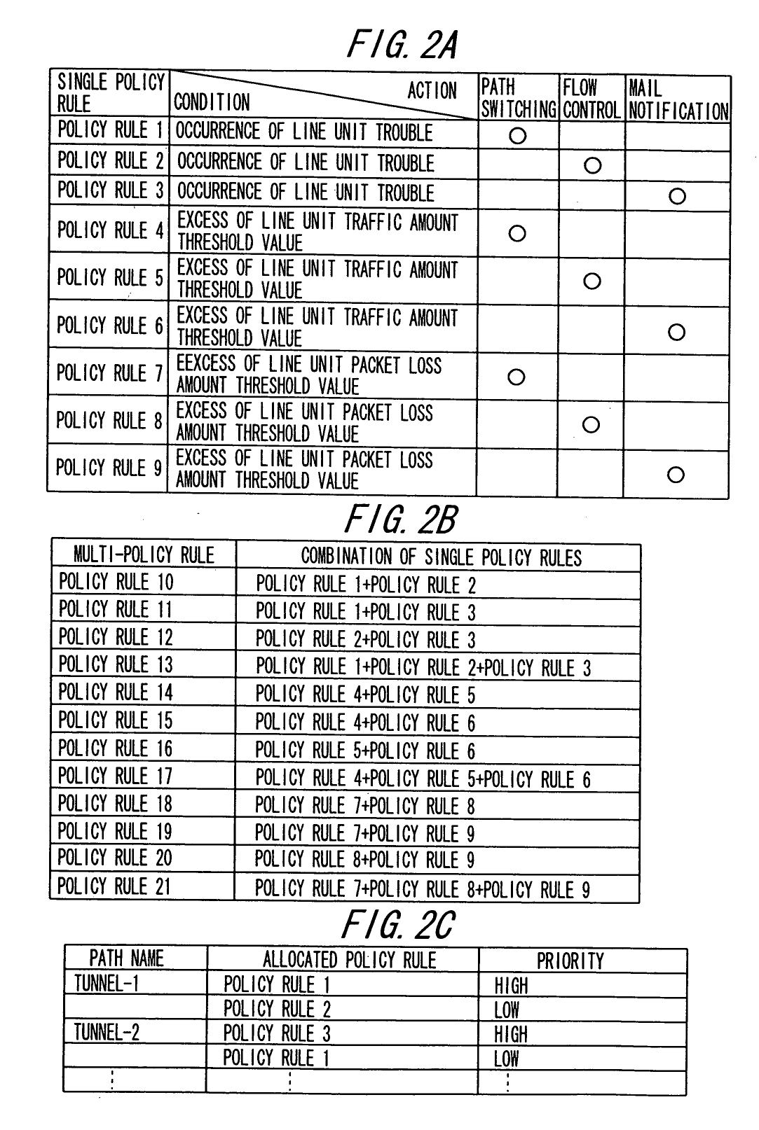

Now, referring to FIGS. 2A and 2B, the single policy rule and the multi-policy rule will be described.

FIG. 2A shows single policy rules for a network regarding traffic engineering. FIG. 2B shows multi-policy rules which the network operator can create by freely combining single policy rules.

According to the network system 1 based on the policy rule, as shown in FIG. 2B, the network operator can create a multi-policy rule which combines a plurality of policy rules shown in FIG. 2A, and finely generate policy rules to be easily understood according to an occasionally changed network operation state.

For example, the network operator can easily create a new policy rule (multi-policy rule) 11 shown in FIG. 2B such as “execute path switching when line trouble occurs, and notify the execution to network operator” by combining two single policies having different actions in the same condition, i.e., a policy rule 1 “policy to execute path switching when line (line unit) trouble occurs” and a policy rule 3 “policy to notify to network operator by mail when line trouble occurs” in FIG. 2A.

The network operator can also easily create a finer new policy rule (multi-policy rule) 13 such as “execute path switching when line trouble occurs, regulate particular flow to the switched path, and notify the policy execution to network operator” by combining three single policy rules having different actions in the same condition, i.e., the policy rule 1 “policy to execute path switching when line trouble occurs”, a policy rule 2 “policy to execute flow control when line trouble occurs”, and the policy rule 3 “policy to notify to network administrator by mail when line trouble occurs” in FIG. 2A.

Next, referring to FIGS. 2A and 2C, a case with consideration given to priority will be described. FIG. 2C shows policy rules with priority where priority freely set by the network operator is allocated to single policies constituting a multi-policy rule.

As shown in FIG. 2C, priority is given to policy rules 1 to 9 for each logical path (e.g., label switch path in MPLS network) in FIG. 2A, and a single policy rule is selected to be executed according to the priority when the multi-policy rule is applied, with the result that the network operator can finely and flexibly generate a single policy rule according to an occasionally changed network operation state.

For example, two single policy rules 1 and 2 constituting a multi-policy rule 10 of the same condition are assigned to a path name “Tunnel 1-1” in FIG. 2C, and the policy rule 1 is higher in execution priority than the policy rule 2. Thus, when a multi-policy rule 10 is applied, the policy rule 1 is always selected preferentially to be executed since the execution priority of the policy rule 1 is higher than that of the policy rule 2. The network operator can easily change the execution priority of the single policy rules in FIG. 2C according to the network operation state.

According to the network system 1 based on the policy rule, the network operator can also set priority among the single policy rules (refer to FIG. 2A) or priority among the multi-policy rules (refer to FIG. 2B) by using policy rules of the same condition as units.

Each policy rule created by the network operator through the user interface unit 101 of the policy server 2 is registered (stored) in a policy management database 110 through a multi-policy management unit 102 as described below. The path name in FIG. 2C is linked with a condition in the policy management database 110 described below.

[Configuration/Function of Policy Server]

Referring to FIG. 1, the policy server 2 reflects a policy rule defined by a condition and its corresponding action to set an operation of each node (network device) present in the network 3 according to a transition of the operation state of the network to be managed.

Thus, the policy server 2 stores a plurality of multi-policy rules generated in units of combination of at least two single policy rules having different actions in the same condition together with particular information of the network device to be applied so that the rules can be updated, and applies one of the plurality of stored multi-policy rules for operation setting of the network device identified based on the above-described particular information.

The policy control device 2 stores a plurality of single policy rules having different actions in the same condition together with the particular information of the network device to be applied and application priority information so that the rules can be updated, and applies one of the plurality of stored single policy rules for operation setting of the network device identified based on the particular above-described information according to an order of priority based on the priority information.

Specifically, the user interface unit 101 of the policy server 2 provides a user interface (GUI: Graphical User Interface) which allows the network operator to create single policy rules, to set an order of priority among the single policy rules, to create a multi-policy rule constituted of a combination of the single policy rules, to set an order of priority among the multi-policy rules, set an order of priority among the single policy rules in the multi-policy rule, and to make a registration request of each policy information through the maintenance/operation terminal (not shown).

The policy management unit 102 stores the policy rules (single policy rules and multi-policy rules) created by the network operator through the user interface unit 101 in a policy management database (DB) 110 to manage them.

A policy analysis unit 201 analyzes the policy rules registered in the policy management database 110 through the policy management unit 102, associates various policy rules with network operation states, and manages the policy rules by using a policy analysis database 210.

A network operation information collection unit 301 receives a request from the policy analysis unit 201, and manages network device information of the network device which becomes a collection target of a network operation state by using a network management database 310.

A network monitoring unit 302 manages pieces of information collected through the IP network 3 in the network management database 310, and periodically refers to the network management database 310 to monitor whether or not there is a change in the network operation state.

The network monitoring unit 302 reads information to be monitored from the network management database 310, and collects pieces of network monitoring state information from the target network devices.

When there is a change in the network operation state, the network operation information collection unit 301 reads pieces of information collected by the network monitoring unit 302 from the network management database 310 to notify them to a network state analysis unit 303.

The network state analysis unit 303 analyzes the notified network operation state to notify it to an optimal policy selection unit 304. The optimal policy selection unit 304 selects an optimal policy by using an order of priority based on the notified network operation state information to notify it to a policy application instruction unit 305.

The policy application instruction unit 305 analyzes the notified policy rule, and requests a policy application unit 306 and an associated processing execution unit 307 to execute processing according to action contents or an order of priority of the policy rule. After the processing request, an application state of a single policy rule of the policy analysis DB 210 is set to application.

The policy application unit 306 executes network control for the network device to be applied according to the policy rule. The associated processing execution unit 307 executes associated processing such as mail notification other than network control for the network device.

[Outline of Operation]

Next, an outline of an operation of the system according to the embodiment of this invention shown in FIG. 1 will be described.

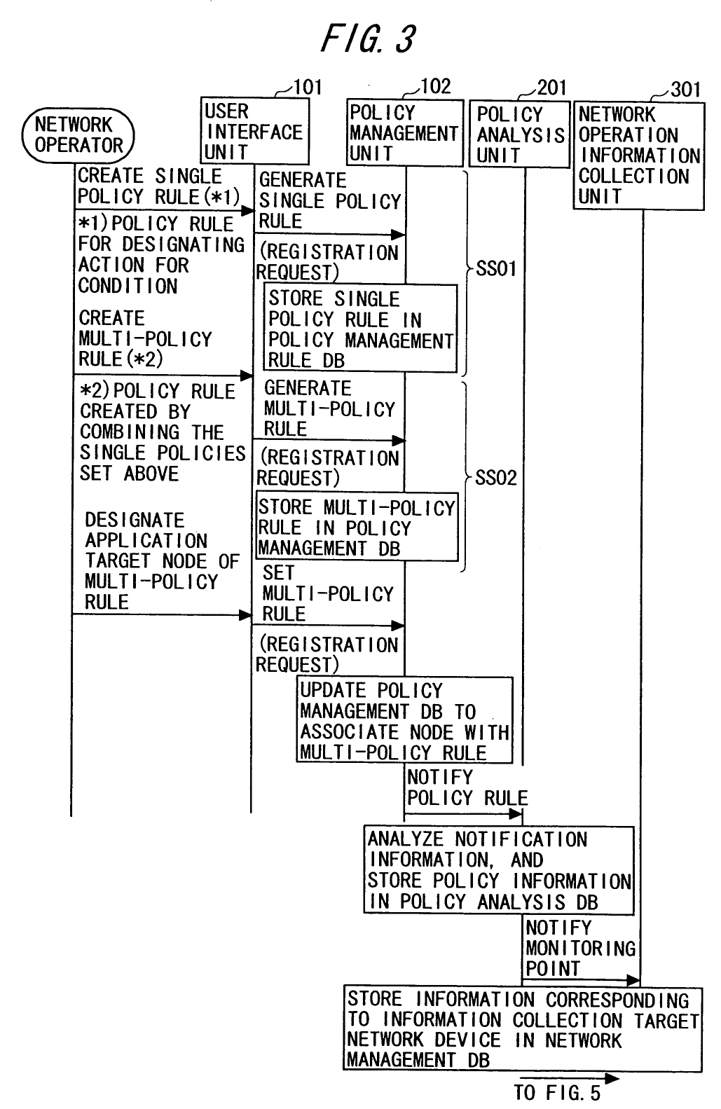

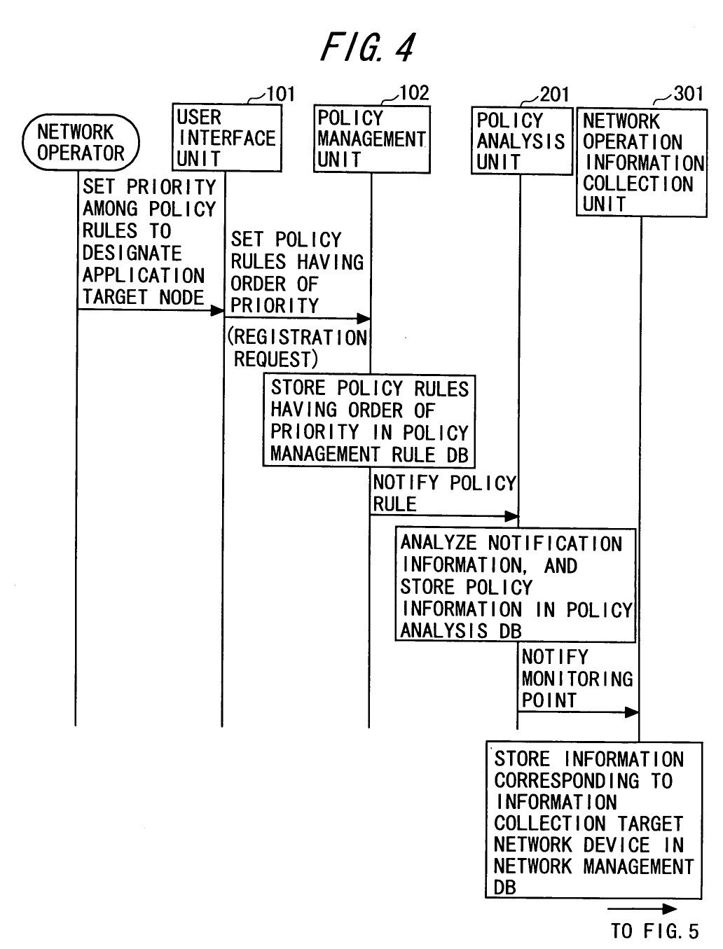

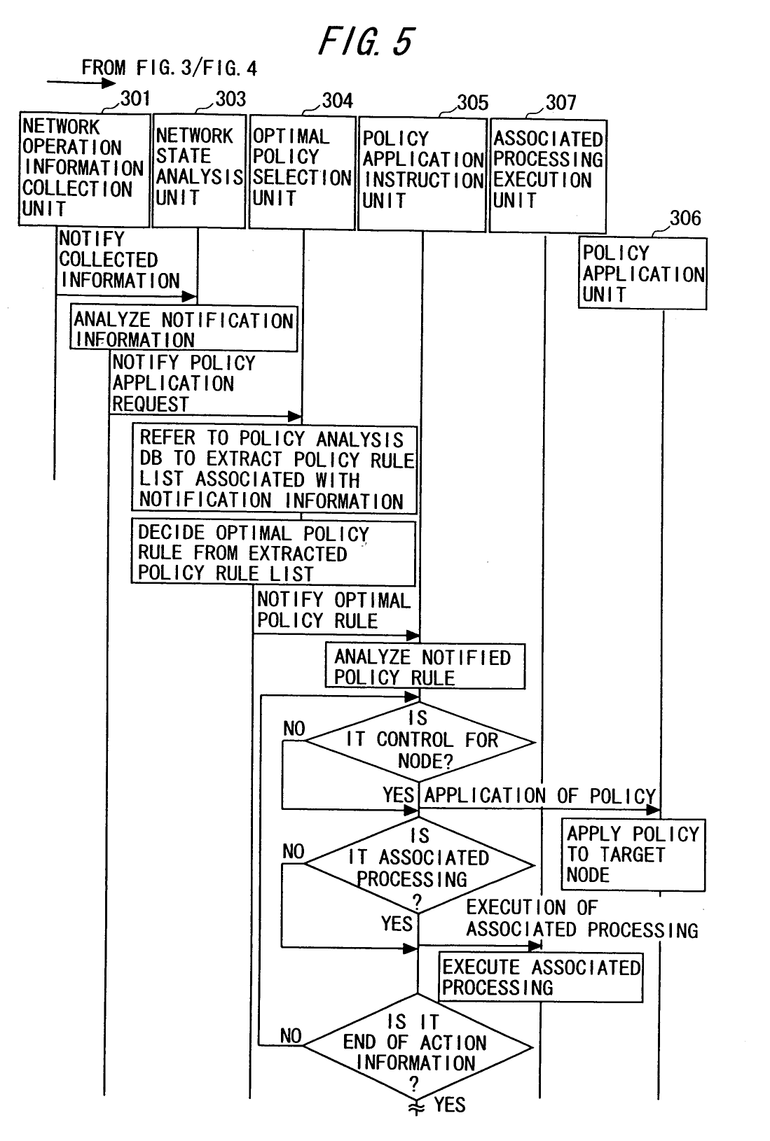

FIG. 3 shows a sequence of registering policy rules. FIG. 4 shows a sequence of registering policy rules with priority. FIG. 5 shows a sequence of applying policy rules.

First, referring to both of FIGS. 1 and 3, an operation of registering single policy rules and multi-policy rules will be described.

The network operator utilizes the maintenance/terminal device connected to the policy server 2 through the IP network (utilization of the terminal is omitted unless particularly specified) to create single policy rules through the user interface unit 101. For this purpose, the network operator must create single policy rules beforehand. The network operator combines a plurality of registered single policy rules to create a multi-policy rule through the user interface unit 101, which enables management of the policy rules from a macroscopic standpoint and creation of finer policy rules. Further, the network operator associates multi-policy rules with nodes (network devices) to be applied and registers them.

In the registration operation of the network operator, single policy rule registration (sequence SS01), multi-policy rule registration (sequence SS02), and various requests regarding multi-policy rule setting which accompanies designation of application target nodes are executed from the user interface unit 101. The policy management unit 102 registers (stores, or updates) policy information of the single policy rules and the multi-policy rules together with associated information in the policy management database 110.

Then, the policy management unit 102 notifies the registration of the policy rules to the policy analysis unit 201. The policy analysis unit 201 analyzes the notified information to store the policy information in the policy analysis data base 210, and notifies a point of monitoring a change in the network operation state to the network operation information collection unit 301. Accordingly, the network operation information collection unit 301 stores the point of monitoring a change in the network operation state, i.e., information corresponding to the network device of an information collection target, in the network management database 310.

Next, referring to both of FIGS. 1 and 4, an operation of registering single policy rules with priority or multi-policy rules with priority will be described.

The network operator utilizes the maintenance/terminal device connected to the policy server 2 to create single policy rules through the user interface unit 101. For this purpose, the network operator must create single policy rules beforehand. The network operator combines a plurality of registered single policy rules to create a multi-policy rule with priority through the user interface unit 101, which enables management of the policy rules from a macroscopic standpoint and creation of finer policy rules. Further, the network operator associates multi-policy rules with nodes (network devices) to be applied and registers them.

In the registration operation of the network operator, single policy rule registration (sequence SS01 shown in FIG. 3), multi-policy rule registration (sequence SS02 shown in FIG. 3), and various requests regarding multi-policy rule setting which accompanies designation of application target nodes are executed to the management unit 102 from the user interface unit 101. The policy management unit 102 registers (stores, or updates) policy information of the single policy rules and the multi-policy rules together with associated information and priority information designated by the network operator in the policy management database 110.

Then, the policy management unit 102 notifies the registration of the policy rules to the policy analysis unit 201. The policy analysis unit 201 analyzes the notified information to store the policy information in the policy analysis data base 210, and notifies a point of monitoring a change in the network operation state to the network operation information collection unit 301. Accordingly, the network operation information collection unit 301 stores the point of monitoring a change in the network operation state, i.e., information corresponding to the network device of an information collection target, in the network management database 310.

Registration of single policy rules with priority can be similarly executed in such a manner that in the registration sequences shown in FIGS. 3 and 4, the network operator executes registration of single policy rules with priority and various requests regarding single policy rule setting accompanying application target node designation to the policy management unit 102 from the user interface unit 101.

Next, referring to both of FIGS. 1 and 5, an operation of applying a single policy rule or a multi-policy rule will be described.

The network operation information collection unit 301 periodically judges whether or not there is a change in the network operation state by referring to the network management database 310. When there is a change in the network operation state, collection information is notified to the network information analysis unit 303.

The network state analysis unit 303 judges whether or not there occurs a change in the network operation state which necessitates application of a single policy rule or a multi-policy rule based on the notified collection information, and notifies a policy application request to the optimal policy selection unit 304 when the single policy rule or the multi-policy rule needs to be applied.

The optimal policy selection unit 304 that has received the notification refers to the policy analysis database 210 to create a list of single policy rules or multi-policy rules which can be applied when a change occurs in the network operation state, and refers to priority of the system (e.g., single policy rule registration order, or priority which single policy has as an attribute) or priority set by the network operator to extract policy rules to be applied from the list. Additionally, the optimal policy selection unit 304 decides an optimal policy rule from the list of extracted policy rules.

The decided optimal policy rule is notified from the optimal policy selection unit 304 to the policy application instruction unit 305. The policy application instruction unit 305 judges whether it is network control for the node (network device) or associated processing such as mail notification other than network control. It instructs network control (policy application instruction) to the policy application unit 306 when the network control for the node is judged, or instructs the associated processing execution unit 307 to execute mail notification corresponding to associated processing in the case other than network control, thereby enabling execution of a plurality of actions.

### SPECIFIC OPERATION EXAMPLE

Next, referring to FIGS. 1 to 18, a specified operation example of the system according to the embodiment of the present invention shown in FIG. 1 will be described.

(Preconditions)

As described above, the IP network 3 in the network system 1 based on the policy rule shown in FIG. 1 includes the plurality of nodes 4 to 7 as the network devices. The operation will be described below by presuming that the plurality of nodes 4 to 7 respectively correspond to network devices A to D.

In this case, it is presumed that the network devices A to D respectively have representative addresses (IP addresses for specifying each of the network devices) 172.27.1.1, 172.27.2.1, 172.27.3.1, and 172.27.4.1 (assigned).

A path of a physical line (physical link) is assigned to the network device A so that the device A can be connected to the network device B through an interface of an IP address 172.27.10.1 which it has, to the network device C through an interface of an IP address 172.27.50.1 which it has, and to the network device D through an interface of an IP address 172.27.60.1 which it has.

Similarly, a path of the physical line is assigned to the network device B so that the device B can be connected to the network device A through an interface of an IP address 172.27.10.2 which it has, to the network device C through an interface of an IP address 172.27.20.1 which it has, and to the network device D through an interface of an IP address 172.27.40.1 which it has.

A path of the physical line is assigned to the network device C so that the device C can be connected to the network device A through an interface of an IP address 172.27.50.2 which it has, to the network device B through an interface of an IP address 172.27.20.2 which it has, and to the network device D through an interface of an IP address 172.27.30.1 which it has.

A path of the physical line is assigned to the network device D so that the device D can be connected to the network device A through an interface of an IP address 172.27.60.2 which it has, to the network device B through an interface of an IP address 172.27.40.2 which it has, and to the network device C through an interface of an IP address 172.27.30.2 which it has.

In this case, the following preconditions are set. A terminal (user terminal) X used by a server user (user) of an IP address 172.27.100.1 is connected to the network device A, and a user terminal Y of an IP address 172.27.200.1 is connected to the network device C.

The policy server 2 has an IP address 172.27.150.1, and pserver@xyz.com set as a mail address.

A path of traffic (IP flow) directly flowing from the network device A to the network device C is set as “Route 1”, and a path of traffic flowing through the network devices A and C is set as “Route 2”.

A policy rule created by the network operator is constituted of a condition and an action. As the condition, a condition as to a state of traffic flowing through the IP network 3 as an object (i.e., trouble of a line through which traffic flows, an excess of a traffic amount threshold, an excess of a packet loss amount threshold value, or the like) can be designated. As the action, an action (switching of a path through which traffic flows, flow control for suppressing traffic, mail notification to the network operator, or the like) with respect to the condition can be designated.

### First Operation Example

According to the network system 1 based on the policy rule of a first operation example, a multi-policy rule is created by combining single policy rules of the same condition according to an operation purpose, with the result that the IP network 3 diversified and instantaneously changed in state can be flexibly controlled.

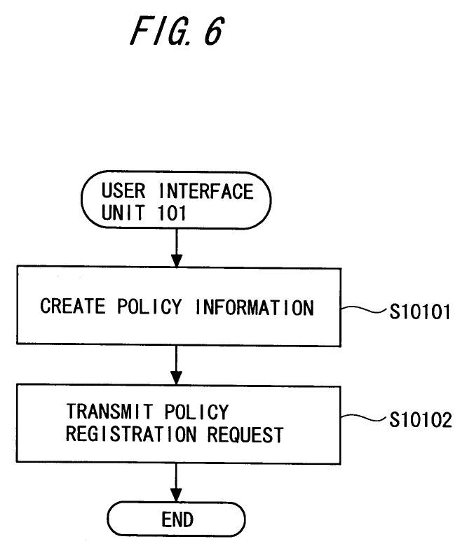

As shown in FIG. 3, the network operator utilizes the maintenance/operation terminal connected to the policy server 2 through the IP network 3 to designate “Policy Rule 1” and make a registration request of a policy rule through the user interface unit 101 (S10101 and S10102 shown in FIG. 6). “Policy Rule 1” includes “Condition 1” as a condition indicating occurrence of a line-basis trouble with regard to the traffic (IP flow) flowing from the user terminal X to the user terminal Y through the route 1 and “Action 1” as an action of path switching so that the traffic can flow from the user terminal X to the user terminal Y through the route 2.

Similarly, the network operator designates “Policy Rule 3” to make a registration request of a policy rule through the user interface unit 101 (S10101 and S10102 shown in FIG. 6). “Policy Rule 3” includes “Condition 2” as a condition indicating a line-basis trouble with regard to the traffic flowing from the user terminal X to the user terminal Y through the route 1 and “Action 2” as an action of mail notification to the network operator.

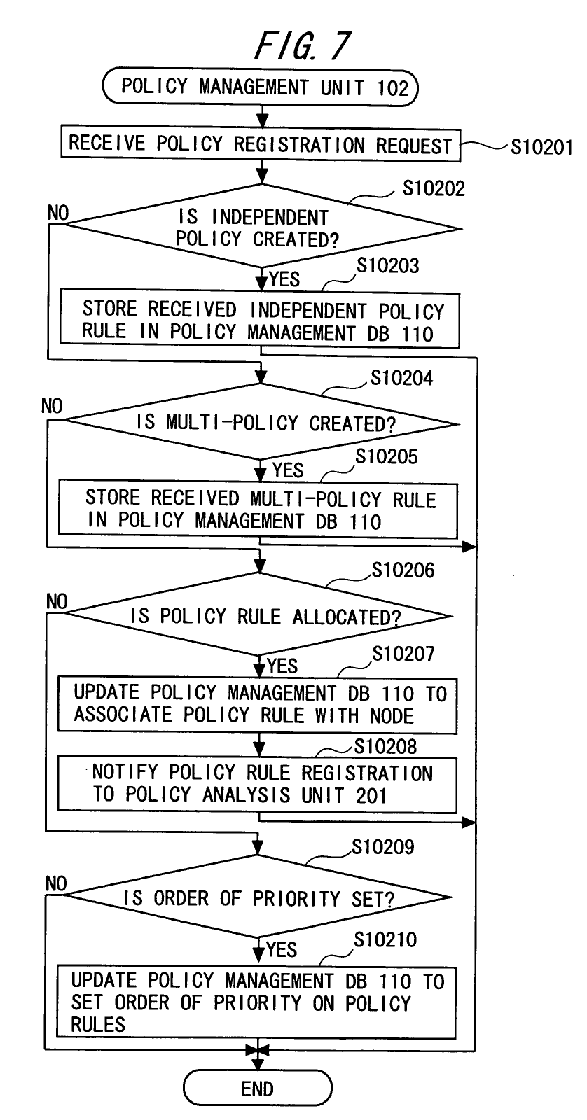

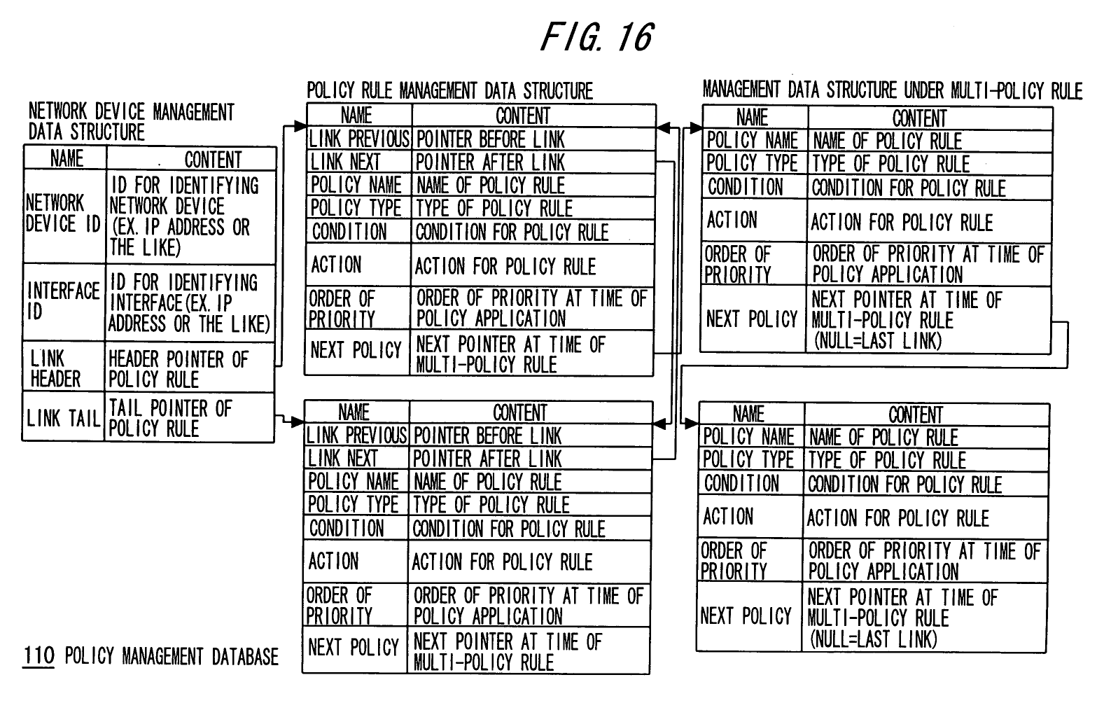

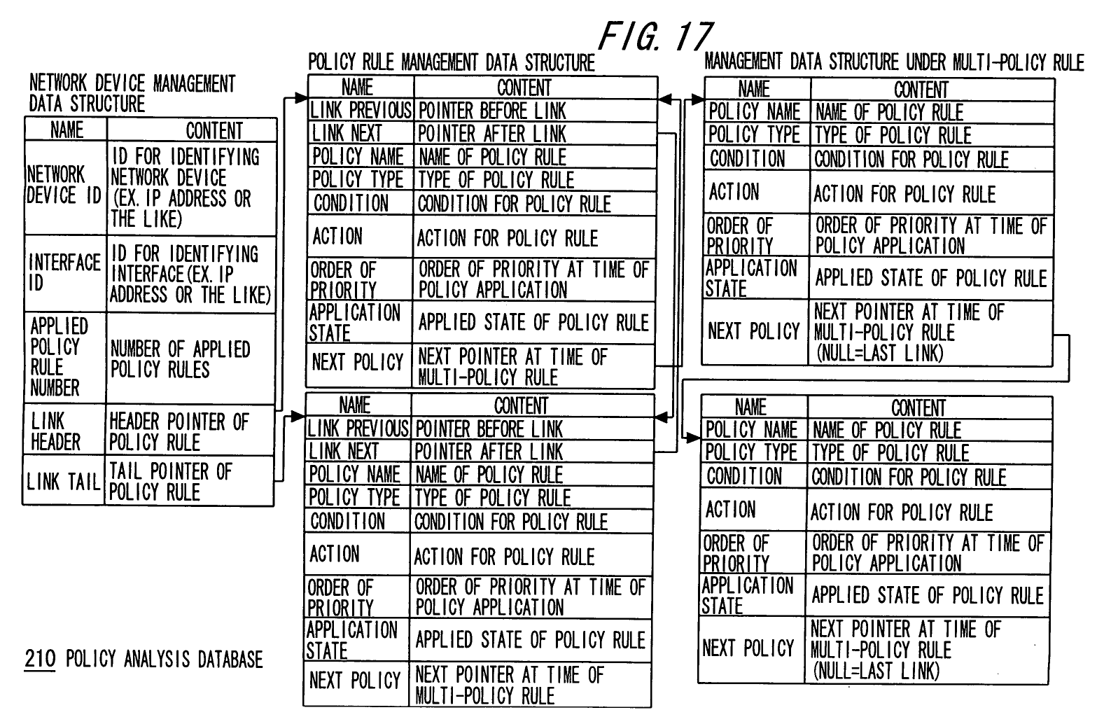

Upon reception of these policy rule registration requests, based on a policy rule management data structure (refer to FIG. 16) of the policy management database 110, the policy management unit 102 generates: an instance 110-P1, where “Policy Rule 1”, “Single Policy”, “Condition 1”, and “Action 1” are respectively set in a policy name, a policy type, a condition, and an action in the case of “Policy Rule 1”; and an instance 110-P2, where “Policy Rule 3”, “Single Policy”, “Condition 2”, and “Action 2” are respectively set in a policy name, a policy type, a condition, and an action in the case of “Policy Rule 3”, to store the generated instance as a policy rule in the policy management database 110 (S10201 to S10203 shown in FIG. 7).

Each of the “Policy Rule 1” and the “Policy Rule 3” is a single policy rule, where the condition and the action are 1 to 1. Accordingly, these policy rules can be registered in the network device itself.

Next, the network operator designates “Policy Rule 1” and “Policy Rule 3”, creates “Policy Rule 11” which combines these single policy rules as a multi-policy rule, and designates a network device of an application target of this multi-policy rule, thereby making a registration request of the multi-policy rule through the user interface unit 101 (S10101 and S10102 shown in FIG. 6). In this case, as the network device of the application target of the “Policy Rule 11” is a network device A corresponding to the node 4, the network operator designates a network device ID “172.27.1.1” and an interface ID (line interface ID) “172.27.50.1”.

Upon reception of the registration request of the multi-policy rule, based on the policy rule management data structure (refer to FIG. 16) of the policy management database 110, the policy management unit 102 generates an instance 110-P3, where “Policy Rule 11”, “Multi-policy”, “Blank”, and “Blank” are respectively set in a policy rule name, a policy type, a condition, and an action to store it as a policy rule in the policy management database 110 (S10201, S10204, and S10205 shown in FIG. 7).

To set the two single policy rules “Policy Rule 1” and “Policy Rule 3” constituting the multi-policy rule “Policy Rule 11” under the “Policy Rule 11”, based on an under-multi-policy rule management data structure (refer to FIG. 16) of the policy management database 110, the policy management unit 102 refers to policy information of the stored “Policy Rule 1” and “Policy Rule 3” to generate an instance 110-P3-1 and an instance 110-P3-2 each constituted of a policy name, a policy type, a condition, and an action. Then, the policy management unit 102 sets the instance 110-P3-1 in a next pointer (Next Policy) of the instance 110-P3 and the instance 110-P3-2 in a next pointer of the instance 110-P3-1.

Based on a network device management data structure (refer to FIG. 16) of the policy management database 110, as network device information corresponding to the network device of the multi-policy rule application target designated by the network operator, the policy management unit 102 generates an instance 110-N1, where “172.27.1.1”, “172.27.50.1”, an instance 110-P3, and an instance 110-P3 are respectively set in an network device ID, an interface ID, a header pointer (Link Header) of a policy rule, and a tail pointer (Link Tail) of a policy rule, and updates management information in the policy management database 110 (S10206 and S10207 shown in FIG. 7).

The policy management unit 102 notifies a network device ID “172.27.1.1” and an interface ID “172.27.50.1” as network device information and “Policy Rule 11” as policy information to the policy analysis unit 201 in the case of a policy rule registered for the network device (S10208 shown in FIG. 7).

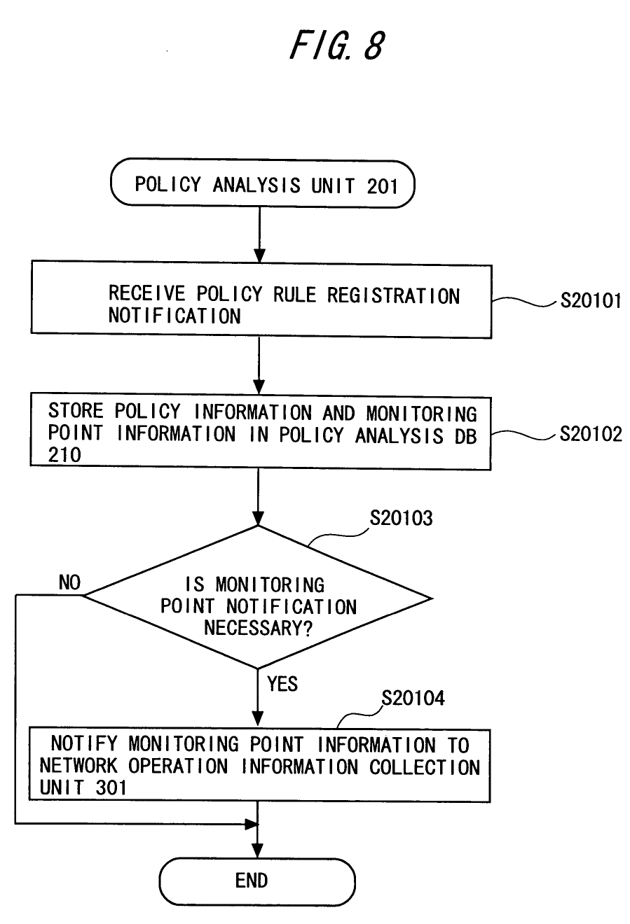

Upon reception of the notification, as shown in a processing flow (S20101 to S20104) of FIG. 8, the policy analysis unit 201 analyzes the notified policy information, and based on a policy rule management data structure (refer to FIG. 17) of the policy analysis database 210, generates an instance 210-P3, where “Policy Rule 11”, “Multi-policy”, “Blank”, and “Blank” are respectively set in a policy rule name, a policy type, a condition, and an action to store the generated instance as a policy rule in the policy analysis database 210.

To set the two single policy rules “Policy Rule 1” and “Policy Rule 3” constituting the “Policy Rule 11” under the “Policy Rule 11”, based on an under-multi-policy rule management data structure (refer to FIG. 17) of the policy analysis database 210, the policy analysis unit 201 generates an instance 210-P3-1, where “Policy Rule 1”, “Single Policy”, “Condition 1”, and “Action 1” are respectively set in a policy name, a policy type, a condition, and an action in the case of the “Policy Rule 1”, and an instance 210-P3-2, where “Policy Rule 3”, “Single Policy”, “Condition 2”, and “Action 2” are respectively set in a policy name, a policy type, a condition, and an action in the case of the “Policy Rule 3”. Then, the policy analysis unit 201 sets the instance 210-P3-1 in a next pointer (Next Policy) of the instance 210-P3 and the instance 210-P3-2 in a next pointer of the instance 210-P3-1.

Next, based on the network device management data structure (refer to FIG. 17) of the policy analysis database 210, the policy analysis unit 201 generates “Instance 210-N1”, where “172.27.1.1”, “172.27.50.1”, “0”, “Instance 210-P3”, and “Instance 210-N1” of the instance 210-P3 are respectively set in a network device ID, an interface ID, the number of applied policy rules, a header pointer (Link Header) to a policy rule, and a tail pointer (Link Tail) to the policy rule to store the generated instance in the policy analysis database 210.

The policy analysis unit 201 notifies network device information (network device ID “172.27.1.1” and interface ID “172.27.50.1”) of the network device as an information collection target of a network operation state to the network operation information collection unit 301.

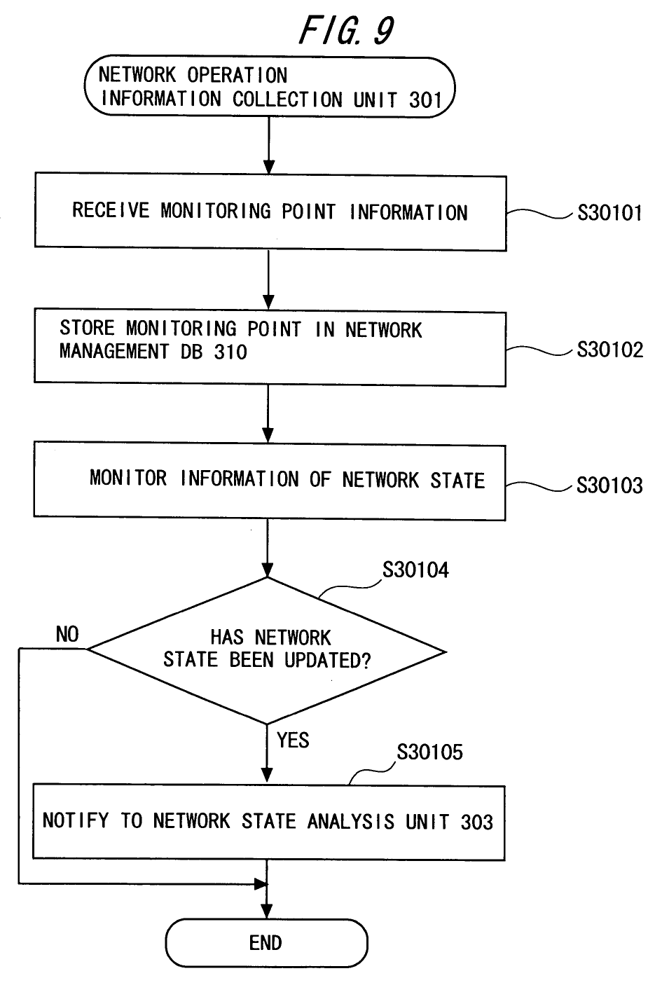

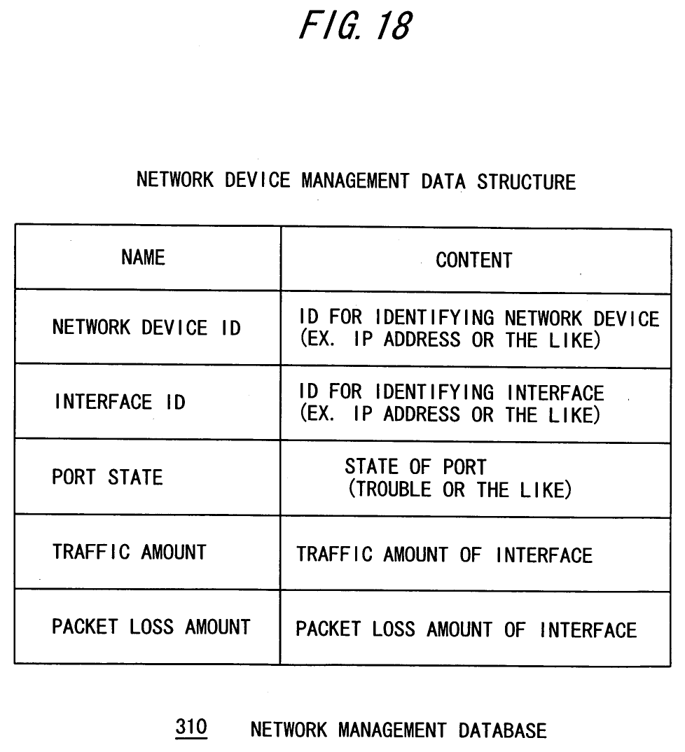

Upon reception of the notification, based on a network management data structure (refer to FIG. 18) of the network management database 310, as information corresponding to the network device of a multi-policy rule application target designated by the network operator, the network operation information collection unit 301 generates an instance 310-N1, where “172.27.1.1”, “172.27.50.1”, “0 (normal)”, “0”, and “0” are respectively set in a network device ID, an interface ID, a port state (line state), a traffic amount (traffic amount of the interface), and a packet loss amount (packet loss amount of the interface) to store the generated instance in the network management database 310 (S30101 and S30102 shown in FIG. 9).

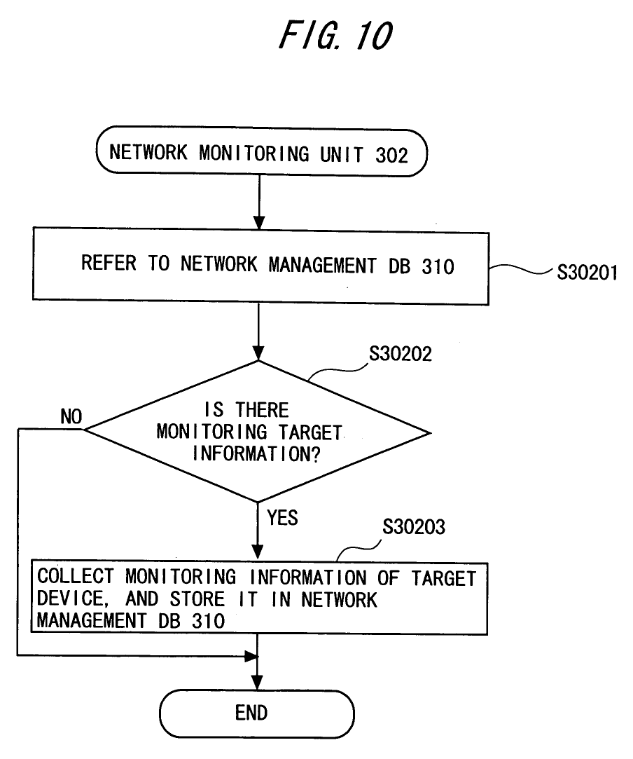

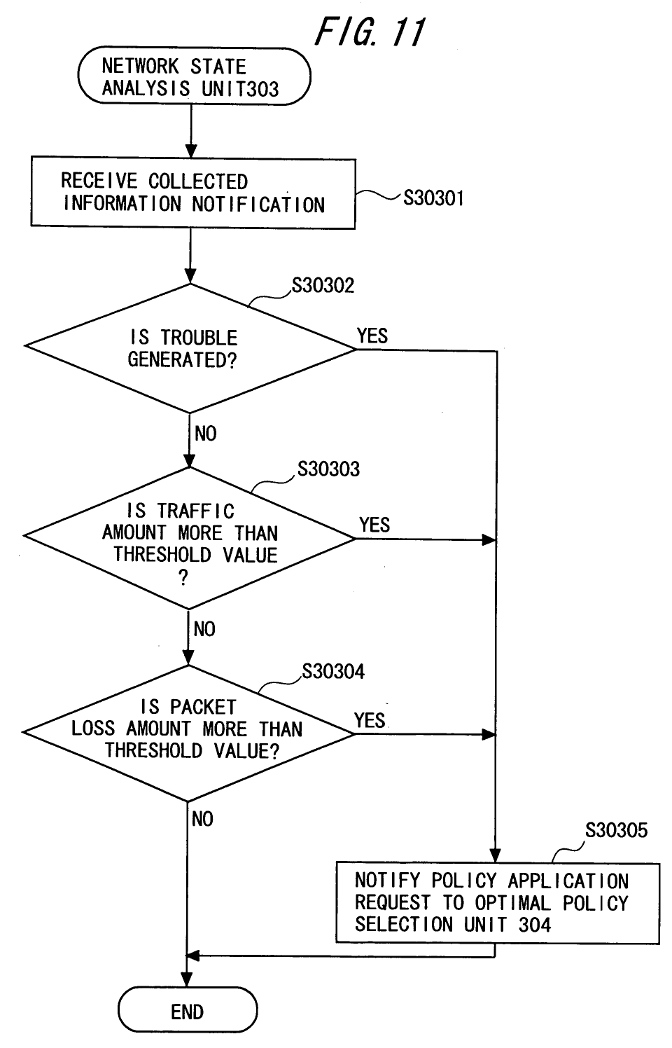

As shown in a processing flow (S30201 to S30203) of FIG. 10, the network monitoring unit 302 periodically refers to the network management database 310 to obtain a network operation state (i.e., line state (port state), traffic amount, and packet loss amount) through communication interface unit (not shown) from a target network device when there is network device information whose network operation state needs to be collected. In this example, as 172.27.1.1 is set as the network device information, the network monitoring unit 302 obtains a network operation state (in this case, line state is “Trouble”, traffic amount is “0”, and packet loss amount is “0”) from the network device corresponding to 172.27.1.1. The network monitoring unit 302 refers to the obtained network operation state to respectively set “1 (Trouble)”, “0”, and “0” in the port state 1, the traffic amount, and the packet loss amount of the instance 310-N1 according to the network management data structure (refer to FIG. 18) of the network management database 310, and updates the information of the network management database 310.

As shown in FIG. 5, the network operation information collection unit 301 refers to the network management database 310 to monitor a change in information of the network operation state (S30103 shown in FIG. 9). In this example, the port state of the instance 310-N1 changes to a state in trouble. Thus, the network ID “172.27.1.1” and the interface ID “172.27.50.1” as the network device information, and the line state “Trouble”, the traffic amount “0”, and the packet loss amount “0” as the information of the network operation state are notified to the network state analysis unit 303 (S30104 and S30105 shown in FIG. 9).

Upon reception of the notification, as shown in a processing flow (S30301 to S30305) of FIG. 11, the network state analysis unit 303 analyzes the notified information of the network operation state, extracts the network device information (network device ID “172.27.1.1” and interface ID “172.27.50.1”) and the operation state (line state “Trouble”, traffic amount “0”, and packet loss amount “0”) of the network device, and notifies the extracted information as a policy application request to the optimal policy selection unit 304.

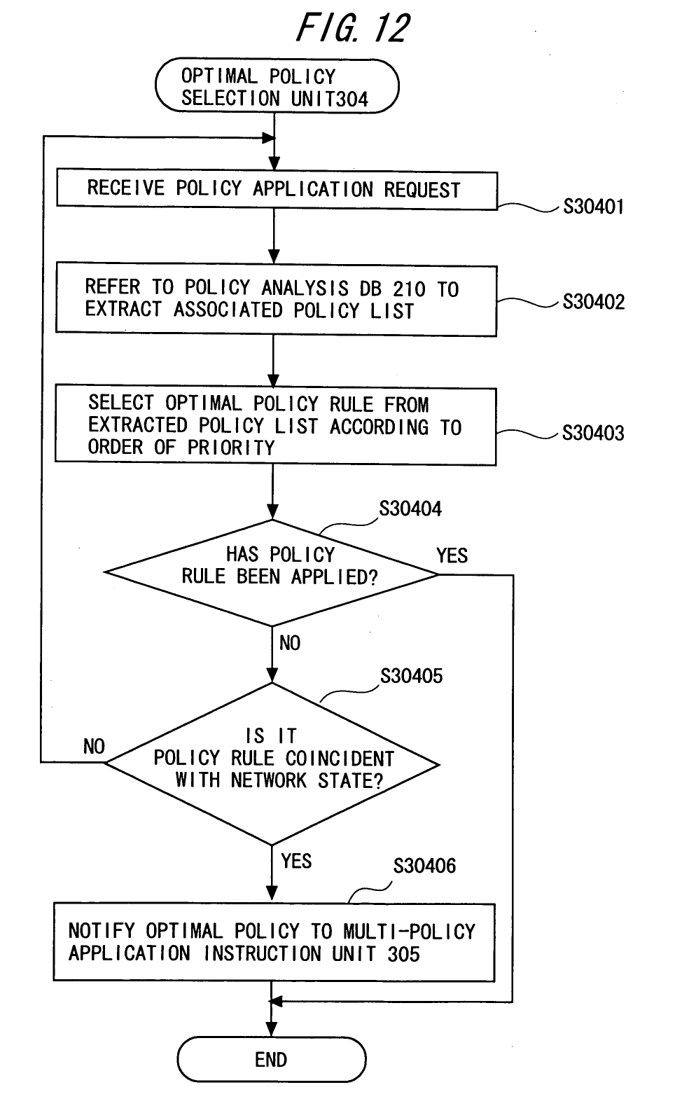

As shown in a processing flow (S30401 to S30406) of FIG. 12, based on the network device ID “172.27.1.1” and the interface ID “172.27.50.1” of the notified network device information, the optimal policy selection unit 304 extracts a list of policy rules registered corresponding to the network device from the policy analysis database 210. Then, the optimal policy selection unit 304 selects (decides) an optimal policy rule from the extracted list of policy rules. In this example, as the multi-policy rule “Policy Rule 11” is registered for the network device, the optimal policy selection unit 304 notifies the selected “Policy Rule 11” to the policy application instruction unit 305.

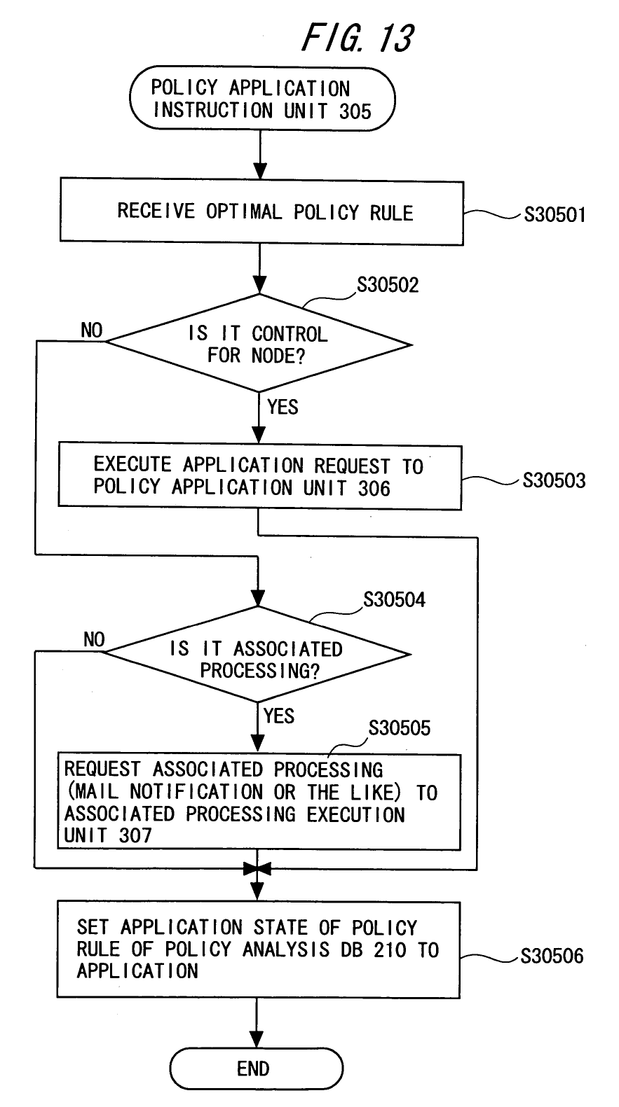

As shown in a processing flow (S30501 to S30506) of FIG. 13, the policy application instruction unit 305 analyzes the notified “Policy Rule 11”, and executes each action in the policy rule (multi-policy rule), in other words, repeats the processing until there are no more single policy rules. In this example, the multi-policy rules “Policy Rule 1” and “Policy Rule 3” are processing targets. As an action in the “policy Rule 1” is path switching to the route 2, the policy application instruction unit 305 requests the policy application unit 306 to apply policies to the network device of the network device ID “172.27.1.1”.

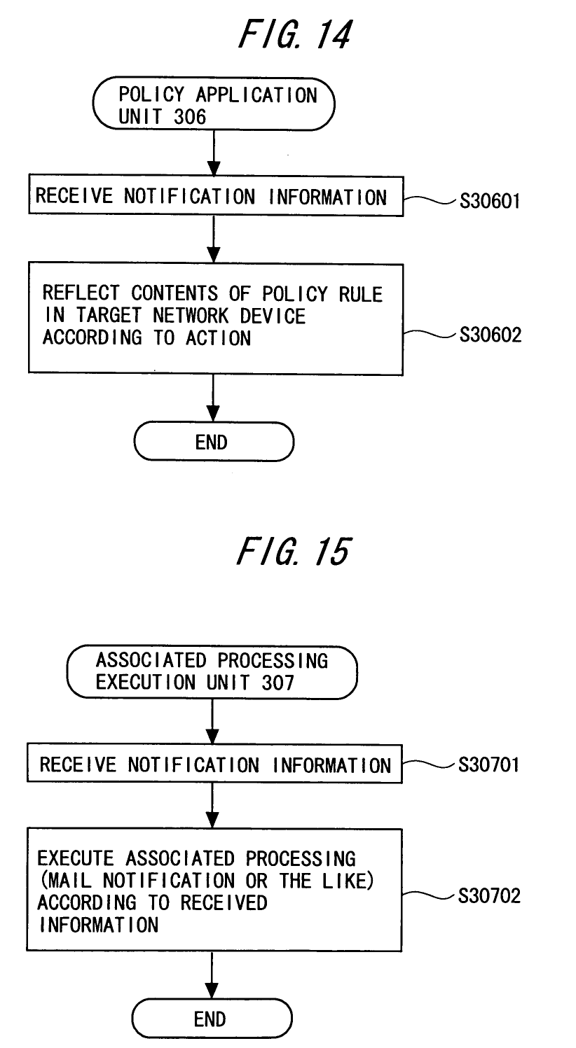

Upon reception of the request, as shown in a processing flow (S30601 to S30602) of FIG. 14, the policy application unit 306 controls the network device of the application target to change a traffic flow path from the route 1 to the route 2.

As the action in the “Policy Rule 3” is mail notification to the network operator, the policy application instruction unit 305 requests the associated processing execution unit 307 to execute processing.

Upon reception of the request, as shown in a processing flow (S30701 to S30702) of FIG. 15, the associated processing execution unit 307 mails a notification of a line trouble to a mail address pserver@xyz.com used by the network operator. After the request of the policy application request to the policy application unit 306, the policy application instruction unit 305 sets an application state of a relevant policy rule of the policy analysis database 210 to “Application”.

Incidentally, the policy application unit 306 and the associated processing execution unit 307 are connected to the IP network 3 through communication interface unit (not shown).

### Second Operation Example

According to the network system 1 based on the policy rule of a second operation example, an order of priority (priority) according to an operation purpose is given to single policy rules of the same condition and application is performed according to the order of priority, with the result that the IP network 3 diversified and instantaneously changed in state can be flexibly controlled.

As shown in FIG. 4, the network operator utilizes the maintenance/operation terminal connected to the policy server 2 to designate “Policy Rule 4” and make a registration request of a policy rule through the user interface unit 101 (S10101 and S10102 shown in FIG. 6). “Policy Rule 4” includes “Condition 4” as a condition indicating that a traffic amount exceeds a line-basis threshold of 40% with regard to the traffic (IP flow) flowing from the user terminal X to the user terminal Y through the route 1 and “Action 4” as an action of path switching so that the traffic can flow from the user terminal X to the user terminal Y through the route 2.

Similarly, the network operator designates “Policy Rule 5” to make a registration request of a policy rule through the user interface unit 101 (S10101 and S10102 shown in FIG. 6). “Policy Rule 5” includes “Condition 5” (equal to “Condition 4”) as a condition indicating that a traffic amount exceeds a line-basis threshold of 40% with regard to the traffic flowing from the user terminal X to the user terminal Y through the route 1 and “Action 5” as an action of performing a flow control for suppressing the traffic flowing from the user terminal X to the user terminal Y.

Upon reception of these policy rule registration requests, based on a policy rule management data structure (refer to FIG. 16) of the policy management database 110, the policy management unit 102 generates: an instance 110-P4, where “Policy Rule 4”, “Single Policy”, “Condition 4”, and “Action 4” are respectively set in a policy name, a policy type, a condition, and an action in the case of “Policy Rule 4”; and an instance 110-P5, where “Policy Rule 5”, “Single Policy”, “Condition 5”, and “Action 5” are respectively set in a policy name, a policy type, a condition, and an action in the case of “Policy Rule 5”, to store the generated instance as a policy rule in the policy management database 101 (S10201 to S10203 shown in FIG. 7).

Next, the network operator sets an order of priority on policy rules in such a manner that priority of the policy rule 4 is “Low”, and priority of the policy rule 5 is “High”, i.e., actions are different in the same condition, and designates a network device of an application target of the policy rules with priority, thereby making a registration request of the policy rules with priority (single policy rules) through the user interface unit 101 (S10101 to S10102 shown in FIG. 6). In this case, as the network device of the application target of the policy rules with priority is a network device A corresponding to the node 4, the network operator designates a network device ID “172.27.1.1” and an interface ID “172.27.50.1”. The priority is not limited to the two kinds of high and low. Three or more kinds such as high, middle, and low may be applied.

The policy management unit 102 that has received the registration request of the policy rules with priority sets “Low” in an order of priority of an instance 110-P4, an instance 100-P5 in a next pointer (Next Policy) of the instance 110-P4, and “High” in an order of priority of an instance 110-P5, and updates the policy management database 110 (S10209 and S10210 shown in FIG. 7).

Based on a network device management data structure (refer to FIG. 16) of the policy management database 110, as network device information corresponding to the network device of the application target of the policy rules with priority designated by the network operator, the policy management unit 102 generates an instance 110-N2, where “172.27.1.1”, “172.27.50.1”, an instance 110-P4, and an instance 110-P5 are respectively set in an network device ID, an interface ID, a header pointer (Link Header) of a policy rule, and a tail pointer (Link Tail) of a policy rule, and updates management information in the policy management database 110 (S10206 and S10207 shown in FIG. 7).

The policy management unit 102 notifies a network device ID “172.27.1.1”, an interface ID “172.27.50.1” as network device information, and “Policy Rule 4” and “Policy Rule 5” as policy information to the policy analysis unit 201 in the case of a policy rule registered for the network device (S10208 shown in FIG. 7).

Upon reception of the notification, as shown in a processing flow (S20101 to S20104) of FIG. 8, the policy analysis unit 201 analyzes the notified policy information and, based on the policy rule management data structure (refer to FIG. 17) of the policy analysis data base 210, generates an instance 210-P4, where “Policy Rule 4”, “Single Policy”, “Condition 4”, “Action 4”, and “Low” are respectively set in a policy name, a policy type, a condition, an action, and an order of priority in the case of the “Policy Rule 4”, or an instance 210-P5, where “Policy Rule 5”, “Single Policy”, “Condition 5”, “Action 5”, and “High” are respectively set in a policy name, a policy type, a condition, an action, and an order of priority, to store it in the policy analysis database 210.

Next, based on the network management data structure (refer to FIG. 17) of the policy analysis database 210, the policy analysis unit 201 generates “Instance 210-N2”, where “172.27.1.1”, “172.27.50.1”, “0”, “Instance 210-P4”, and an instance 210-P5 are respectively set in a network device ID, an interface ID, the number of applied policy rules, a header pointer (Link Header) to a policy rule, and a tail pointer (Link Tail) to the policy rule to store it in the policy analysis database 210.

The policy analysis unit 201 notifies network device information (network device ID “172.27.1.1” and interface ID “172.27.50.1”) of the network device as an information collection target of a network operation state to the network operation information collection unit 301 as a monitoring point.

Upon reception of the notification, based on a network management data structure (refer to FIG. 18) of the network management database 310, as information corresponding to the network device of an application target of the policy rules with priority designated by the network operator, the network operation information collection unit 301 generates an instance 310-N1, where “172.27.1.1”, “172.27.50.1”, “0 (normal)”, “0”, and “0” are respectively set in a network device ID, an interface ID, a port state (line state), a traffic amount (traffic amount of the interface), and a packet loss amount (packet loss amount of the interface to store it in the network management database 310 (S30101, and S30102 shown in FIG. 9).

As shown in a processing flow (S30201 and S30202) of FIG. 10, the network monitoring unit 302 periodically refers to the network management database 310 to obtain a network operation state (i.e., line state (port state), traffic amount, and packet loss amount) through communication interface unit (not shown) from a target network device when there is network device information whose network operation state needs to be collected. In this example, as 172.27.1.1 is set as the network device information, the network monitoring unit 302 obtains a network operation state (a line state is “Normal”, a traffic amount is “50 Mbps”, a packet loss amount is “0”, and a physical band of the interface is “100 Mbps”) from the network device corresponding to 172.27.1.1. The network monitoring unit 302 refers to the obtained network operation state to respectively set “0 (Normal)”, “50 Mbps”, and “0” in the port state, the traffic amount, and the packet loss amount of the instance 310-N2 according to the network management data structure (refer to FIG. 18) of the network management database 310, and updates the information of the network management database 310.

As shown in FIG. 5, the network operation information collection unit 301 refers to the network management database 310 to monitor a change in information of the network operation state (S30103 shown in FIG. 9). In this example, the traffic amount of the instance 310-N2 changes. Thus, the network ID “172.27.1.1” and the interface ID “172.27.50.1” as the network device information, and the line state “Normal”, the traffic amount “50 Mbps”, and the packet loss amount “0” as the information of the network operation state are notified to the network state analysis unit 303 (S30104 and S30105 shown in FIG. 9).

Upon reception of the notification, as shown in a processing flow (S30301 to S30305) of FIG. 11, the network state analysis unit 303 analyzes the notified information of the network operation state, extracts the network device information (network device ID “172.27.1.1” and interface ID “172.27.50.1”) and the operation state (line state “Normal”, traffic amount “50 Mbps”, and packet loss amount “0”) of the network device, and notifies the extracted information as a policy application request to the optimal policy selection unit 304.

As shown in a processing flow (S30401 to S30406) of FIG. 12, based on the network device ID “172.27.1.1” and the interface ID “172.27.50.1” of the notified network device information, the optimal policy selection unit 304 extracts a list of policy rules registered corresponding to the network device from the policy analysis database 210. Then, the optimal policy selection unit 304 selects (determines) an optimal policy rule from the extracted list of policy rules according to priority. In this example, as a traffic amount for a physical band of 100 Mbps is 50 Mbps, the optimal policy selection unit 304 judges that a ratio is 50%, that is, a traffic amount exceeds a threshold of 40%. Thus, since the single policy rules “Policy Rule 4” and “Policy Rule 5” are registered for the network device, and priority of the “Policy Rule 5” is “High”, the “Policy Rule 5” is selected. The optimal policy selection unit 304 notifies the selected “Policy Rule 5” to the policy application instruction unit 305.

As shown in a processing flow (S30501 to S30505) of FIG. 13, the policy application instruction unit 305 analyzes the notified “Policy Rule 5”, and executes each action in the policy rule (multi-policy rule), in other words, repeats the processing until there are no more single policy rules. In this example, the “Policy Rule 5” is a single policy rule, and the number of actions is one. Thus, this action alone becomes a processing target. As an action in the “policy Rule 5”, flow control is executed to suppress traffic from the user terminal X to the user terminal Y. Hence, the policy application instruction unit 305 requests the policy application unit 306 to apply policies to the network device of the network device ID “172.27.1.1”.

Upon reception of the request, as shown in a processing flow (S30601 and S30602) of FIG. 14, the policy application unit 306 executes flow control for the network device of the application target. After the policy application request to the policy application unit 306, the policy application instruction unit 305 sets an application state of a relevant policy rule of the policy analysis database 210 to “Application”.

### Third Operation Example

As an alternative to the second operation example, the network operator utilizes the maintenance/operation terminal connected to the policy server 2 to create multi-policy rules to which plural kinds of priority (e.g., highest, high, middle, and low) are assigned. For example, as shown in FIGS. 2A and (B), priorities of “Low”, “High”, “Highest”, and “Middle” are respectively assigned to multi-policy rules 10 to 13 created by combining single policy rules 1 to 3 belonging to the same condition regarding “Line-basis Trouble Occurs”.

The network operator additionally designates a network device (e.g., network device of network device ID “172.27.1.1” and interface ID “172.27.50.1”) to which the multi-policy rules with priority are applied.

Thus, a policy rule registration request is made to the policy management unit 102 through the user interface unit 101. As a result, as in the case of the application of the single policy rule with priority of the second operation example, policy application using priority can be carried out for the multi-policy rule with priority.

According to the network system 1 based on the policy rule of the third operation example, by setting the order of priority on the plurality of multi-policy rules constituted of the plurality of single policy rules belonging to the same condition and applying them, it is possible to deal with the IP network 3 having an added value more flexibly.

### Fourth Operation Example

According to the network system 1 based on the policy rule of the fourth operation example, by setting an order of priority on a plurality of single policy rules of a multi-policy rule, it is possible to deal with the IP network 3 having an added value more flexibly.

As an alternative to the first operation example, the network operator utilizes the maintenance/operation terminal connected to the policy server 2 to set an order of priority “Low” and “High”, for example, on two single policy rules “Policy Rule 1” and “Policy Rule 3” of a multi-policy rule “Policy Rule 11” as shown in FIG. 2C, thereby designating a network device (e.g., network device of network device ID “172.27.1.1” and interface ID “172.27.50.1”) to which the “Policy Rule 11” is applied. Accordingly, a policy rule registration request can be made to the policy management unit 102 through the user interface unit 101.

The policy management unit 102 that has received the registration request sets “Low” for an order of priority of an instance 110-P3-1 and “High” for an order of priority of an instance 110-P3-2 as a difference from the first operation example.

The policy analysis unit 201 sets “Low” for an order of priority of an instance 210-P3-1 and “High” for an order of priority of an instance 210-P3-2 as a difference from the first operation example.

Furthermore, as a difference from the first operation example, the policy application instruction unit 305 sequentially executes application processing for “Policy Rule 3” and “Policy Rule 1” according to an order of priority on the single policy rules of the multi-policy rule. After the application processing, the policy application instruction unit 305 sets an application state of a relevant policy rule of the policy analysis database 210 to “Application”.

### MODIFIED EXAMPLE

The process of the embodiment described above is provided as a program to be executed by a computer, and can be provided through a recording medium such as a CD-ROM or a flexible disk and a communication line.

The processing operations of the embodiment described above can be implemented by arbitrarily combining a plural number or all thereof.

### INDUSTRIAL APPLICABILITY

The network system based on the policy rule according to the present invention, which enables suppression of a monotonous increase in single policy rules brought about by an operation and a great reduction in loads on the network operator can be applied to an IP network such as an MPLS network operated by the policy server.

What is claimed is:

1. A policy control device for reflecting a policy rule defined by a condition and an action corresponding to the condition for operation setting of respective network devices present in a network to be managed, according to a transition of operation states of the network, comprising:
a storage unit for storing a plurality of multi-policy rules generated in units of combination of at least two single policy rules having different actions on the same condition, together with particular information of a network device to be applied, in such a manner that the plurality of multi-policy rules and the particular information can be updated; and
a control unit for applying one of the plurality of multi-policy rules stored in the storage unit for the operation setting of the network device identified, based on the particular information.

2. A policy control device for reflecting a policy rule defined by a condition and an action corresponding to the condition for operation setting of respective network devices present in a network to be managed, according to a transition of operation states of the network, comprising:
a storage unit for storing a plurality of single policy rules having different actions on the same condition, together with particular information of a network device to be applied and application priority information, in such a manner that the plurality of single policy rules, the particular information, and the application priority information can be updated; and
a control unit for applying one of the plurality of single policy rules stored in the storage unit for the operation setting of the network device identified, based on the particular information according to an order of priority, based on the priority information.

3. A policy control device according to claim 1, wherein:
the condition contains at least one selected from among a line trouble, an excess of a traffic amount threshold value, and an excess of a packet loss threshold value each indicating operation states of the network to be managed; and
the action contains at least two selected from among switching of a traffic flow path, flow control for suppressing traffic, and a notification to a network operator.

4. A policy control device according to claim 1, wherein the particular information of the network device to be applied contains identification information of the network device and identification information of a line interface.

5. A policy control device according to claim 1, wherein each of the plurality of multi-policy rules is generated in units of combination of at least two of the single policy rules having the different actions on the same condition preregistered in the storage unit, to enable hierarchical management of the plurality of multi-policy rules.

6. A policy control device according to claim 1, wherein:
the storage unit further stores application priority information of the plurality of multi-policy rules in such a manner that the application priority information can be updated; and
the control unit applies one of the plurality of multi-policy rules for the operation setting of the network device, according to an order of priority based on the priority information.

7. A policy control device according to claim 1, wherein:
the storage unit further stores application priority information of the single policy rules in each of the plurality of multi-policy rules in such a manner that the application priority information can be updated; and
the control unit applies the single policy rules in each of the plurality of multi-policy rules for the operation setting of the network device, according to an order of priority based on the priority information.

8. A policy control method for reflecting a policy rule defined by a condition and an action corresponding to the condition for operation setting of respective network devices present in a network to be managed, according to a transition of operation states of the network, comprising:
storing a plurality of multi-policy rules generated in units of combination of at least two single policy rules having different actions on the same condition, together with particular information of a network device to be applied, in such a manner that the plurality of multi-policy rules and the particular information can be updated; and
applying one of the plurality of multi-policy rules stored for the operation setting of the network device identified, based on the particular information.

9. A policy control method for reflecting a policy rule defined by a condition and an action corresponding to the condition for operation setting of respective network devices present in a network to be managed, according to a transition of operation states of the network, comprising:
storing a plurality of single policy rules having different actions on the same condition, together with particular information of a network device to be applied and application priority information, in such a manner that the plurality of single policy rules, the particular information, and the application priority information can be updated; and
applying one of the plurality of single policy rules stored for the operation setting of the network device identified, based on the particular information according to an order of priority based on the priority information.

10. A policy control method according to claim 8, wherein:
the condition contains at least one selected from among a line trouble, an excess of a traffic amount threshold value, and an excess of a packet loss threshold value each indicating operation states of the network to be managed; and
the action contains at least two selected from among switching of a traffic flow path, flow control for suppressing traffic, and a notification to a network operator.

11. A policy control method according to claim 8, wherein the particular information of the network device to be applied contains identification information of the network device and identification information of a line interface.

12. A policy control method according to claim 8, wherein each of the plurality of multi-policy rules is generated in units of combination of at least two of the single policy rules having the different actions on the same condition preregistered, to enable hierarchical management of the plurality of multi-policy rules.

13. A policy control method according to claim 8, further comprising:
storing application priority information of the plurality of multi-policy rules in such a manner that the application priority information can be updated; and
applying one of the plurality of multi-policy rules for the operation setting of the network device, according to an order of priority based on the priority information.

14. A policy control method according to claim 8, further comprising:
storing application priority information of the single policy rules in each of the plurality of multi-policy rules in such a manner that the application priority information can be updated; and
applying the single policy rules in each of the plurality of multi-policy rules for the operation setting of the network device, according to an order of priority based on the priority information.
